(19) United States
(12) Patent Application Publication
(10) Pub. No.: US 2014/0174971 A1
(43) Pub. Date: Jun. 26, 2014

(54) MEDICAL STERILE PACKAGING AND PACKAGING METHOD

(71) Applicant: Aesculap AG, Tuttlingen (DE)

(72) Inventors: Stephan Lindner, Wurmlingen (DE); Fabian Hoefer, Tuttlingen (DE)

(73) Assignee: Aesculap AG, Tuttlingen (DE)

(21) Appl. No.: 14/108,443

(22) Filed: Dec. 17, 2013

(30) Foreign Application Priority Data
Dec. 21, 2012 (DE) 10 2012 112 945

(51) Int. Cl. A61J 1/00

(52) U.S. Cl. CPC A61J 1/00
USPC 206/438; 53/426

(57) ABSTRACT

The invention relates to a medical sterile packaging, which defines a receiving space for at least one implant, which is formed for temporary or permanent insertion in a human or animal body, which receiving space is closed in a sterile and germ-proof manner in a storage disposition of the sterile packaging for the sterile packaging of the at least one implant, wherein the sterile packaging is produced from one or more cleanable and sterilisable materials.

### CROSS-REFERENCE TO RELATED APPLICATIONS

This application claims the benefit of German patent application number 10 2012 112 945.2, filed Dec. 21, 2012, which is incorporated by reference herein in its entirety and for all purposes.

### FIELD OF THE INVENTION

The present invention relates to medical sterile packagings generally, and more specifically to a medical sterile packaging, which defines a receiving space for at least one implant, which is formed for temporary or permanent insertion in a human or animal body, which receiving space is closed in a sterile and germ-proof manner in a storage disposition of the sterile packaging for the sterile packaging of the at least one implant.

Further, the present invention relates to packaging methods generally, and more specifically to a packaging method for the sterile packaging of at least one implant, which is formed for temporary or permanent insertion in a human or animal body.

### BACKGROUND OF THE INVENTION

To provide implants, plastics material mountings are frequently used for them. Mountings of this type allow the implants to be held and allow the operator free choice of access to the implant required in each case for a surgical intervention. Examples of complex implants are, in particular screws, for example pedicle screws. A problem, in particular in the case of complex implants is that sterile implants provided for a surgical intervention, which are not implanted, can nevertheless become soiled in the course of the intervention. Typical soiling is produced, in this case, for example, by blood, body tissue or body fluids, with which the implants may come into contact. So that the implants that were not required do not have to be disposed of, but can be used again, in other words provided, for a future intervention, it is necessary to reprocess the contaminated, non-implanted implants. A processing in this sense comprises, in particular, the mechanical cleaning, for example by hand or in a washing or cleaning machine provided for this, in particular including the use of suitable cleaning agents and/or solvents. After cleaning, the implants are then also sterilised. There is used in particular in this connection hot steam sterilisation, which is frequently used in hospitals and surgeries.

One problem when preparing complex implants, in other words, for example, implants with indentations or complicated threads, is that, in particular, cleaning corresponding to specifications cannot be ensured, in particular in the plastics material mountings currently available. In particular, not only impurities, but also cleaning substances, can undesirably remain in gaps or cavities of the implants.

### SUMMARY OF THE INVENTION

In a first aspect of the invention, a medical sterile packaging defines a receiving space for at least one implant, which is formed for temporary or permanent insertion in a human or animal body. The receiving space is closed in a sterile and germ-proof manner in a storage disposition of the sterile packaging for the sterile packaging of the at least one implant. The sterile packaging is produced from one or more cleanable and sterilisable materials.

In a second aspect of the invention, a packaging method for the sterile packaging of at least one implant, which is formed for temporary or permanent insertion in a human or animal body, is provided. Said method comprising: Packaging the at least one implant in a medical sterile packaging, which defines a receiving space for at least one implant, which is formed for temporary or permanent insertion in a human or animal body. Said receiving space is closed in a sterile and germ-proof manner in a storage disposition of the sterile packaging for the sterile packaging of the at least one implant. The sterile packaging is produced from one or more cleanable and sterilisable materials

### BRIEF DESCRIPTION OF THE DRAWING FIGURES

The foregoing summary and the following description may be better understood in conjunction with the drawing figures, in which:

FIG. 1a: shows a schematic sectional view of a first embodiment of a sterile packaging before the introduction or insertion of an implant;

FIG. 1b: shows a schematic sectional view of the first embodiment of a sterile packaging from FIG. 1a after the introduction of the implant and closure;

FIG. 2a: shows a schematic sectional view of a second embodiment of a sterile packaging before the introduction of an implant;

FIG. 2b: shows a schematic sectional view of the second embodiment of a sterile packaging from FIG. 2a after the introduction of the implant and closure;

FIG. 3a: shows a schematic sectional view of a third embodiment of a sterile packaging before the introduction of an implant;

FIG. 3b: shows a schematic sectional view of the third embodiment of a sterile packaging from FIG. 3a after the introduction of the implant and closure;

FIG. 4a: shows a schematic sectional view of a fourth embodiment of a sterile packaging before the introduction of an implant;

FIG. 4b: shows a schematic sectional view of the fourth embodiment of a sterile packaging from FIG. 4a after the introduction of the implant and closure;

FIG. 5a: shows a schematic view of a fifth embodiment of a closed sterile packaging with implant;

FIG. 5b: shows a schematic view of the fifth embodiment of a sterile packaging from FIG. 5a after opening and the removal of the implant;

FIG. 6a: shows a schematic view of a sixth embodiment of a closed sterile packaging with implant;

FIG. 6b: shows a schematic view of the sixth embodiment of a sterile packaging from FIG. 6a after opening and removal of the implant;

FIG. 7a: shows a schematic sectional view of a seventh embodiment of a sterile packaging before the introduction of an implant;

FIG. 7b: shows a schematic sectional view of the seventh embodiment of a sterile packaging from FIG. 7a after the introduction of the implant and closure;

FIG. 8a: shows a schematic sectional view of an eighth embodiment of a sterile packaging before the introduction of an implant;

FIG. 8b: shows a schematic sectional view of the eighth embodiment of a sterile packaging from FIG. 8a after the introduction of the implant and closure;

FIG. 9: shows a schematic section view of a ninth embodiment of a sterile packaging after the introduction of the implant and closure;

FIG. 10: shows a schematic sectional view of a tenth embodiment of a sterile packaging after the introduction of the implant and closure;

FIG. 11: shows a schematic sectional view of an eleventh embodiment of a sterile packaging after the introduction of two implants and closure;

FIG. 12a: shows a schematic sectional view of a twelfth embodiment of a sterile packaging from FIG. 8a after the introduction of the implant and closure; and

FIG. 12b: shows a schematic view of the removal opening of the twelfth embodiment of a sterile packaging from FIG. 12a after opening and removal of the implant.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a medical sterile packaging, which defines a receiving space for at least one implant, which is formed for temporary or permanent insertion in a human or animal body, which receiving space is closed in a sterile and germ-proof manner in a storage disposition of the sterile packaging for the sterile packaging of the at least one implant, wherein the sterile packaging is produced from one or more cleanable and sterilisable materials.

The sterile packaging proposed according to the invention makes it possible to provide an implant that is sterile in accordance with specifications for a surgical intervention. The sterile packaging produced from one or more cleanable and sterilisable materials can thus be sterilised as a whole. This means that the implant can be provided in the sterile packaging, which forms a protective sheath and which is in turn itself sterilised, for a surgical intervention. The implant is only then removed from the medical sterile packaging that is sterile not only on the inside but also on the outside, when it is actually required for an intervention. On completion of the surgical intervention, all the implants not required, which are still packaged in a sterile manner in their respective medical sterile packaging, are reprocessed in their sterile packaging, in other words in their protective sheath. This means that the sterile packaging with the implant contained therein is firstly cleaned from the outside, for example manually or by means of a washing or cleaning machine that is suitable for this, in particular also using cleaning agents and solvents, and is then sterilised, for example by means of hot steam sterilisation. The sterile packagings thus cleaned and sterilised can then be stored, for example in a sterile and a germ-proof manner until the next surgical intervention, for example in a sterile container. Cleaning and sterilisation in accordance with specifications of the sterile packaging can be ensured, in particular, by simple geometries of the sterile packaging. Unlike the conventional procedure, the implant itself does not have to be cleaned and sterilised, but only the sterile packaging surrounding the implant. In particular, a simple geometry can be achieved in that any indentations are dispensed with on the sterile packaging, in which indentations soiling and germs could collect. Indentation-free sterile packagings can be easily and safely cleaned and sterilised. The cleanable and sterilisable materials, from which the sterile packaging is produced, preferably allow several hundreds or thousands of reprocessing cycles to be carried out. As a result, the reprocessing outlay can not only be minimised, but so can the number of implants to be kept available as a whole, for example in a hospital or surgery. Significant costs can thus be reduced and high standards simultaneously nevertheless maintained in the sterile quality. The sterile packaging proposed according to the invention as a whole allows rapid and safe access to the required implants. In comparison to conceivable double blister packagings, relatively little waste is produced. The space requirement for the implants is not increased compared to conventional holders. And, finally, the implants can be prepared as usual and optionally also cleaned by a machine, not, however, loose, but in the sterile packaging. The sterile packaging is preferably gas-tight, in particular, air-tight, and/or steam-tight. It is favourable if a leak rate is less than about 10⁻³ mbar/s. In particular, the proposed sterile packaging is easy and practical to handle, storable and preferably bacteria-proof.

It is favourable if the materials are solvent-resistant to cleaning agents and solvents with a pH in the range from about 2 to about 12. The one or more cleanable and sterilisable materials, in the following also called material(s), are preferably solvent-resistant to cleaning agents and solvents with a pH in a range from about 3 to about 11. Cleaning can thus selectively take place in an acid or alkaline environment, without the sterile packaging being damaged by the cleaning and the sterility of the implant packaged in the sterile packaging thus being endangered. The materials from which the sterile packaging is produced are preferably resistant to cleaning agents which are acidic, neutral or alkaline and optionally may contain a surfactant additive. Furthermore, it is favourable if the materials are mechanically stable, in particular, when wiped with a cloth and/or when subjected to immersion disinfection and cleaned with a brush and optionally also when cleaned ultrasonically. A cleaning temperature, in particular, of the cleaning agents used preferably lies in a range from about 40° C. to about 98° C. It is favourable if a cleaning time lies in a range from about 1 minute to about 60 minutes.

In order, in particular, to be able to sterilise the cleaned sterile packaging by means of hot steam sterilisation, it is advantageous if the material(s) are heat-resistant up to a temperature of at least about 150° C. In particular, it is favourable if the material(s) are heat-resistant to a temperature of at least about 130° C. With materials of this type it is possible to sterilise the sterile packaging in conventional hot steam sterilisation appliances, and specifically without the sterile packaging being damaged and the sterility of the implant packaged therein being endangered. The sterile packaging is preferably formed such that sterilisation with steam is made possible, in particular, at a pressure in a range from about 1 bar to about 4 bar, a temperature from about 100° C. to about 144° C. and a sterilisation time in a range from about 1 minute to about 60 minutes.

The material(s) are preferably pressure-resistant at pressures up to at least about 5 bar. The material(s) are advantageously pressure-resistant at pressures to at least about 3 bar. The pressure resistance or compressive strength is preferably at least 7 bar. With materials of this type it is possible to form a sterile packaging, which can be subjected to hot steam sterilisation in conventional hot steam sterilisation appliances, without the sterile packaging being damaged.

It is advantageous for the handling of the sterile packaging if the latter is dimensionally stable. In particular, it is formed in such a way that at temperatures of at least about 150° C. and at pressures up to at least about 5 bar, it retains its original shape or substantially retains it. As a result, in the case of a deformation of the sterile packaging, indentations or complex geometries can be prevented from being able to form thereon, which cannot be cleaned or only with an extremely large cleaning outlay.

In order to facilitate the use of the sterile packaging for the user, it is advantageous if the material(s) are transparent or translucent. Thus a user can, for example, directly recognise what is contained in the sterile packaging. In particular, the implant packaged in the sterile packaging can thus be selected by sight by a user.

Advantageously, the material(s) are glass, metal, plastics material or ceramics. In particular, the sterile packaging can be produced from a plurality of different materials, for example from any combinations of the materials mentioned. However, it is also conceivable to form the sterile packaging from only one material, in particular also in one piece. In particular, the metal may comprise one or more steels, for example, stainless steels with the material numbers 1.4021, 1.4024, 1.4028, 1.4031, 1.4034, 1.4104, 1.4112, 1.4116, 1.4121, 1.4125, 1.4301, 1.4305, 1.4310, 1.4401, 1.4435, 1.4441, 1.4541, 1.4543, 1.4568 and/or 1.4571. The plastics material may be or contain, in particular, polyetheretherketone (PEEK).

To make the loading of the sterile packaging with at least one implant as simple as possible, it is favourable if the sterile packaging comprises a container to receive at least one implant with an introduction opening and a closure element to close the introduction opening. The at least one implant can be introduced or inserted through the introduction opening into the container, which can in turn be closed by means of the closure element. The loading of the sterile packaging with the at least one implant preferably takes place in a sterile environment. Optionally, it is also possible to sterilise the at least one implant again in the sterile packaging adopting the storage disposition, for example by irradiation with gamma radiation. The introduction opening can also be called and has the function of an insertion opening for inserting at least one implant into the packaging.

In the storage disposition, the container and the closure element are advantageously connected to one another in force- and/or shape-locking manner. As a result, it can be ensured that the closure element cannot be undesirably released from the container, which could result in the at least one implant packaged in the sterile packaging becoming contaminated or non-sterile.

The container and the closure element can be particularly easily connected to one another in force-locking manner if they are glued and/or welded to one another in the storage disposition. In particular, it is advantageous to weld the container and the closure element by means of a laser. In the case of gluing, adhesives are preferably used, which are pressure-resistant and heat-resistant as well as solvent-resistant in order to be able to carry out conventional cleaning processes to reprocess the sterile packaging.

At least one weld seam is preferably provided for the secure connection of the container and the closure element in the storage disposition. The at least one weld seam is advantageously in the form of a closed ring. An additional sterile barrier can thus be provided, for example. If two self-contained weld seams are provided, a redundant, in other words double, sterile barrier can be formed, for example.

Opening the sterile packaging becomes particularly easy if the latter has at least one predetermined breaking point for opening. This, for example, allows the at least one implant to be removed from the sterile packaging by specific destruction of the predetermined breaking point.

The predetermined breaking point is advantageously formed on the container and/or on the closure element. This allows a part of the closure element or a part of the container to be selectively removed in order to thus provide a removal opening.

The predetermined breaking point can be formed particularly easily by a weakening of the material forming the container and/or the closure element. For example, a wall thickness of the container and/or of the closure element can be reduced slightly to form the predetermined breaking point. The predetermined breaking point advantageously allows the sterile packaging to be opened without the aid of tools.

It is favourable if a sterile packaging produced from a plastics material has a minimum wall thickness of about 2 mm. A maximum wall thickness of the sterile packaging produced from a plastics material is preferably about 7 mm. It is favourable if a sterile packaging produced from a metal, in particular, a steel has a minimum wall thickness of about 0.5 mm. A maximum wall thickness of the sterile packaging produced from a metal is preferably about 5 mm.

The production of the sterile packaging becomes easier if the predetermined breaking point comprises a groove. This can, in particular, be peripheral, for example on an outer surface of the container or of the closure element. The groove is advantageously open in a direction facing away from the sterile packaging. A groove of this type can be formed particularly easily on the sterile packaging, for example by milling or corresponding shaping during a moulding process to produce the closure element or the container.

In order to allow an opening of the sterile packaging that is as well-defined as possible, it is advantageous if the groove has a V-shaped cross section.

In order to easily allow the closure of the container, the container and the closure element can preferably be screwed to one another.

The container and the closure element can, for example, be screwed to one another in a particularly simple manner in that the container has an internal container thread or an external container thread and in that the closure element has an external closure element thread corresponding to the internal container thread or an internal closure element thread corresponding to the external container thread.

The stability of the packaging and its germ-proofness can, in particular, be improved in that the closure element has a projection entering the introduction opening in the storage disposition. The projection may, in particular, be in the form of a plug. The closure element, in this case, is preferably formed from a material, which has a certain resilience, in order to ensure a seal of the introduction opening.

It may furthermore be favourable if the closure element has a flange abutting on an edge or an edge face of the introduction opening in the storage disposition. Thus, a seal can easily be achieved between the closure element and the edge of the container.

In order to protect the introduction opening or an edge thereof, it is advantageous if the closure element has an edge portion annularly surrounding the container in the region of the introduction opening. The closure element can thus, in particular, be in the form of a cap, which engages over the introduction opening. Both the introduction opening and the closure element are preferably rotationally symmetrical or substantially rotationally symmetrical.

The wall portion is advantageously cylindrical or substantially cylindrical. Thus, it can, for example, be dimensioned to correspond to a cylindrical wall portion of the introduction opening in order to securely close the introduction opening.

The closure element can be produced economically and can be removed easily and safely from the container, for example, in that it has the form of a crown cap.

According to a preferred embodiment of the invention, a sealing element may be provided to seal the container and the closure element relative to one another. For example, the sealing element in a crown cap may be in the form of an insert arranged on an inside thereof, which has a certain resilience. The sealing element can, in particular be formed from sterilisable plastics materials, such as, for example, polyvinyl chloride (PVC), polyethylene (PE) or polyetheretherketone (PEEK).

The sealing element advantageously abuts, in the storage disposition, on a container sealing face of the container and on a closure element sealing face of the closure element. For example, the container sealing face can be formed by an edge surrounding the introduction opening and directed away from the container and the closure element sealing face can be formed by a corresponding flange of the closure element.

In order to facilitate the closure of the sterile packaging, it is advantageous if the sealing element is held or fastened on the container or on the closure element. For example, it can be held in a force- and/or shape-locking manner on the container or on the closure element. In particular, the sealing element can be adhered or welded to the container or to the closure element.

The sterile packaging can be produced particularly easily and economically if the closure element is produced from a film/foil or a thin metal sheet. In particular, the foil/film may be a metal or a plastics material foil/film or a multi-layer foil/film with at least one metal and/or plastics material layer in each case. For example, a foil/film can be stretched over an introduction opening of the container and connected to the container by point or laser welding. Alternatively, the foil/film or the thin metal sheet can also be adhered to the container.

The container is particularly easy to produce if it has a cylindrical or substantially cylindrical wall. The container can optionally also be rotationally symmetrical as a whole. For example, it can be formed from a tubular blank by hammering it closed on one side and forming a corresponding closure element to close the other tube end.

According to further preferred embodiment of the invention, at least one tool element can be provided to at least partially remove the closure element to open the sterile packaging. The at least one tool element can, in particular, be formed in one piece with the closure element or be permanently connected thereto. Obviously, the at least one tool element may optionally also be arranged and formed in such a way that a part of the container can be removed to open the sterile packaging.

Particularly easy and safe handling of an implant is allowed by a sterile packaging if the at least one tool element is in the form of a pull member. For example, the pull member can be grasped by a user and a corresponding pulling force can thus be exerted on a part of the sterile packaging in order, for example, to open the sterile packaging by forming a removal opening. The removal opening can be predefined, for example by a predetermined breaking point, which, in particular, can be in the form of above-described, advantageous embodiments of predetermined breaking points. A pull member in the form of a pull tab is particularly easy to handle. For example, a finger can thus be inserted through the tab and the sterile packaging opened safely.

In order to ensure that non-sterile sterile packagings and therefore also non-sterile implants cannot inadvertently reach the sterile region during a surgical intervention, it is advantageous if the sterile packaging comprises an indicator device to indicate whether the sterile packaging has been opened or damaged. The indicator device can, in particular, be of a mechanical nature and, for example, comprise a predetermined breaking point, which can be checked by a user before use of the sterile packaging and the implant contained therein, for example by a visual check.

It is favourable if the indicator device comprises an oxygen indicator. The oxygen indicator is advantageously arranged in the receiving space. It may, in particular, be formed in such a way that when it makes contact with oxygen, its colour changes in order to thus indicate to a user that the sterile packaging is untight and consequently no longer sterile.

Furthermore, it may be advantageous if the sterile packaging comprises at least one memory element for storing information to characterise at least one implant packaged in the sterile packaging. For example, data relating to the type of implant, its size, its production date or its batch designation can be stored on the memory element. In particular, the memory element can be used to document a surgical intervention in order to later be able to retrace which implant(s) were actually implanted.

The handling of the sterile packaging and the course of a surgical intervention can, in particular, be optimised in that the memory element can be read contactlessly. For example, it can be configured to be read optically or wirelessly.

A memory element can be provided particularly easily and economically if it is in the form of a bar code or a colour coding or is part of an RFID chip. Memory elements of this type can be read optically, for example using a bar code scanner, or by means of an RFID chip reading appliance. The configuration in the form of a colour coding has the advantage that it is directly possible for a user to recognise the content of the sterile packaging with the aid of the colour coding.

The memory element can be produced particularly easily and economically if the closure element is coloured to form the colour coding. As a result, different implant sizes can be selected, for example, with the aid of the colour.

It is advantageous if the medical sterile packaging comprises at least one implant packaged in the receiving space in the storage disposition. It is thus possible for a producer of implants to already package an implant in a sterile manner in the sterile packaging and to thus deliver it in a sterile manner. The sterile packaging with the implant does not, however, absolutely have to be packaged again in a sterile manner. It is basically possible to sterilise the implant packaged in the sterile packaging before the actual use on site, for example in a hospital. This reduces the packaging and storage outlay.

Furthermore, the present invention relates to a packaging method for the sterile packaging of at least one implant, which is formed for temporary or permanent insertion in a human or animal body, said method comprising: Packaging the at least one implant in a medical sterile packaging, in particular one of the above-described sterile packagings, which defines a receiving space for at least one implant, which is formed for temporary or permanent insertion in a human or animal body, which receiving space is closed in a sterile and germ-proof manner in a storage disposition of the sterile packaging for the sterile packaging of the at least one implant, wherein the sterile packaging is produced from one or more cleanable and sterilisable materials.

Packaging at least one implant in accordance with this method in such a medical sterile packaging has the advantage that a laborious processing of the implant itself can be dispensed with as only the sterile packaging surrounding the implant has to be processed in order to be able to reprocess an implant not required during a surgical intervention for a later intervention.

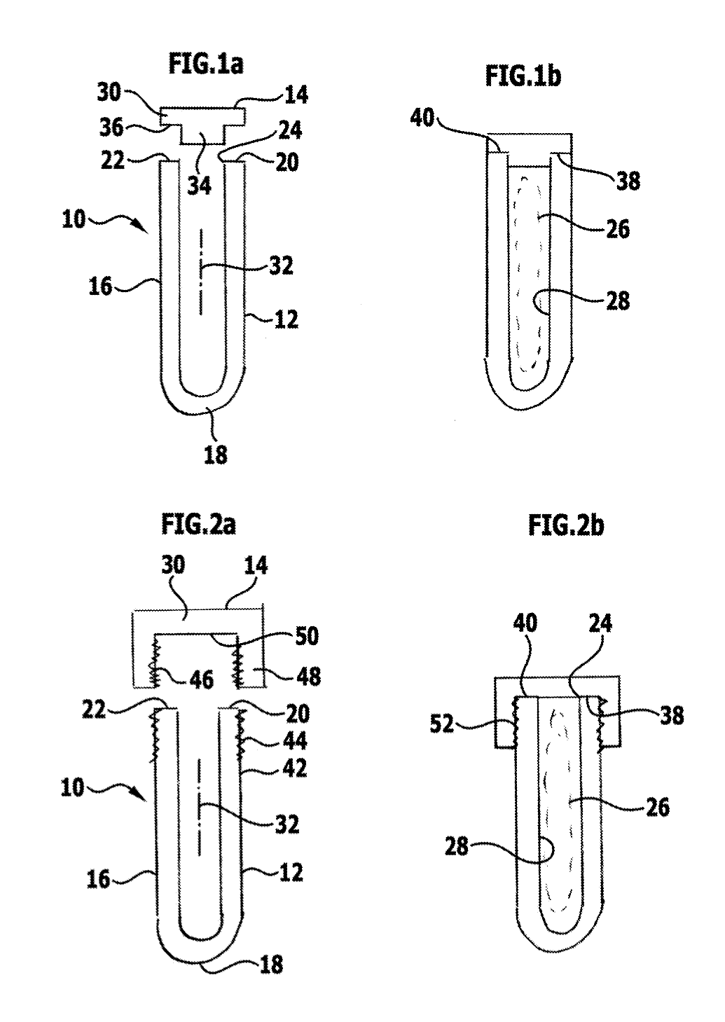

FIG. 1 schematically shows a first embodiment of a sterile packaging designated by the reference numeral 10 as a whole. It comprises a container 12 and a closure element 14. Both the container 12 and the closure element 14 are preferably rotationally symmetrical. The container 12 is produced from a tube 16, which is closed at its one end 18 by hammering, so a substantially half hollow sphere is produced. The opposite end 20 defines an annularly closed edge face 22, which is directed away from the end 18 and surrounds an introduction opening 24, through which an implant 26, which is formed for temporary or permanent insertion in a human or animal body, can be introduced into a receiving space 28 defined by the sterile packaging 10.

The closure element 14 is in the form of a circular disc 30, from which a cylindrical projection 34 projecting coaxially with respect to a longitudinal axis 32 defined by the container 12 extends away. The projection 34 is dimensioned such that it can be introduced into the introduction opening 24 in shape-locking manner. The projection 34 adjoins an annular face 36 of the disc 30, which defines a closure element sealing face 38, which, in a storage disposition of the sterile packaging, in which it is closed in a sterile and germ-proof manner for the sterile packaging of the implant 26, abuts on the edge face 22 forming a container sealing face.

The container 12 and the closure element 14 can optionally be connected to one another in force-locking manner and/or by a substance-to-substance bond, for example by gluing or welding. The container 12 and the closure element 14 may be produced from the same material or from different materials. The container 12 may, for example, be produced from a high-grade steel and the closure element 14 may also be produced from a high-grade steel or from a plastics material. FIG. 1b schematically shows the first embodiment of the sterile packaging 10 in the storage disposition.

A second embodiment of a sterile packaging 10 is shown schematically in FIG. 2a. The structure of the container 12 substantially corresponds to the structure of the container 12 of the first embodiment of the sterile packaging 10 shown schematically in FIGS. 1a and 1b. For the sake of clarity, identical elements and parts of the embodiment already described and the embodiments described below of sterile packagings 10 are provided with identical reference numerals.

The container 12 has a short external thread portion 44 on an exterior 42. Said external thread portion is formed to correspond with an internal thread portion 46 on a cylindrical portion 48 of the closure element 14. The portion 48 is closed pointing away from the container 12 with a circular disc 30. An internal face 50 of the closure element 14 facing in the direction of the container 12 forms the closure element sealing face 38, which abuts on the container sealing face 40.

The implant 26 can be introduced through the introduction opening 24 when the closure element 14 is removed. The closure element 14 can then be screwed onto the container 12. To secure the screw connection and for optional sealing, some adhesive 58 can be applied to the external thread portion 44 and/or the internal thread portion 46 in order to connect the closure element 14 in force-locking manner or with a substance-to-substance bond to the container 12.

The container 12 and the closure element 14 may, for example, both be produced from a high-grade steel. Alternatively, it is also possible to produce the closure element 14 from glass or a plastics material, which may be coloured with a specific colour, for example depending on the type of implant 26 to be packaged in the sterile packaging 10, in order to thus form a colour coding for the implant 26.

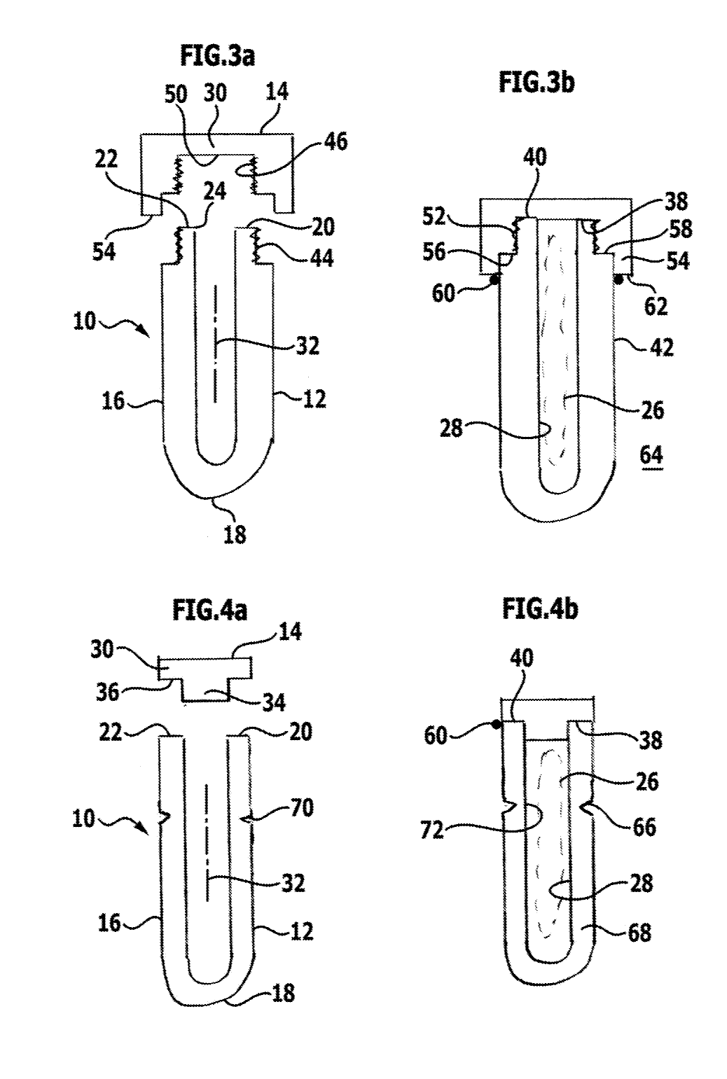

A third embodiment of a sterile packaging 10 is shown schematically in FIGS. 3a and 3b. With respect to its basic structure, it corresponds to the second embodiment of the sterile packaging 10 shown schematically in FIGS. 2a and 2b. The difference from the second embodiment is that an external diameter of the container 12 reduces in one step toward the end 20, specifically to a length corresponding to a length of the external thread portion 44. On the closure element 14, a second cylindrical portion 54 formed concentrically with respect to the longitudinal axis 32 extends away from the portion 48, oriented in the direction of the container 12, which has an internal diameter, which corresponds to an external diameter of the container 12, where this is thread-free. In the storage disposition, in which the closure element 14 is screwed onto the container 12, the portion 54 engages over the thread-free exterior 42. An annular face 46 oriented in the direction of the container 12, which abuts on an annular face 48 of the container 12 oriented in the direction of the closure element 14, is formed on the closure element 14. The external threaded portion 44 extends between the annular face 58 and the edge face 22.

After the implant 26 has been introduced into the receiving space 28, the closure element 14 is screwed onto the container 12. To fix the closure element 14 in the storage disposition shown in FIG. 3b, a weld seam can optionally be applied in the transition region between an annular face 62 of the portion 54 oriented in the direction of the end 18 and the outside 42, for example by laser welding. The weld seam 60 can, in particular, be in the form of a closed ring and thus additionally seal the receiving space 28 relative to the surroundings 64 of the sterile packaging 10. Alternatively or in addition, an adhesive 52 can also be used in order to glue the external threaded portion 44 to the internal threaded portion 46.

A fourth embodiment of a sterile packaging 10 is schematically shown in FIGS. 4a and 4b. With respect to its structure, it substantially corresponds to the embodiment of the sterile packaging 10 shown in FIGS. 1a and 1b and differs therefrom merely in that a predetermined breaking point 66 is provided on the container 12. The predetermined breaking point 66 is formed by a weakening of the material forming the container 12, specifically by a reduction in a thickness of a wall 68 of the container 12. The reduction in the thickness of the wall 68 to form the predetermined breaking point 66 is realised by a groove 70, which annularly surrounds the container 12 on its outside 42 and has a V-shaped cross section.

To open the sterile packaging 10, the predetermined breaking point 66 can be severed by unscrewing or snapping off and the implant 26 can then be removed through the removal opening 72 formed in the region of the predetermined breaking point 66.

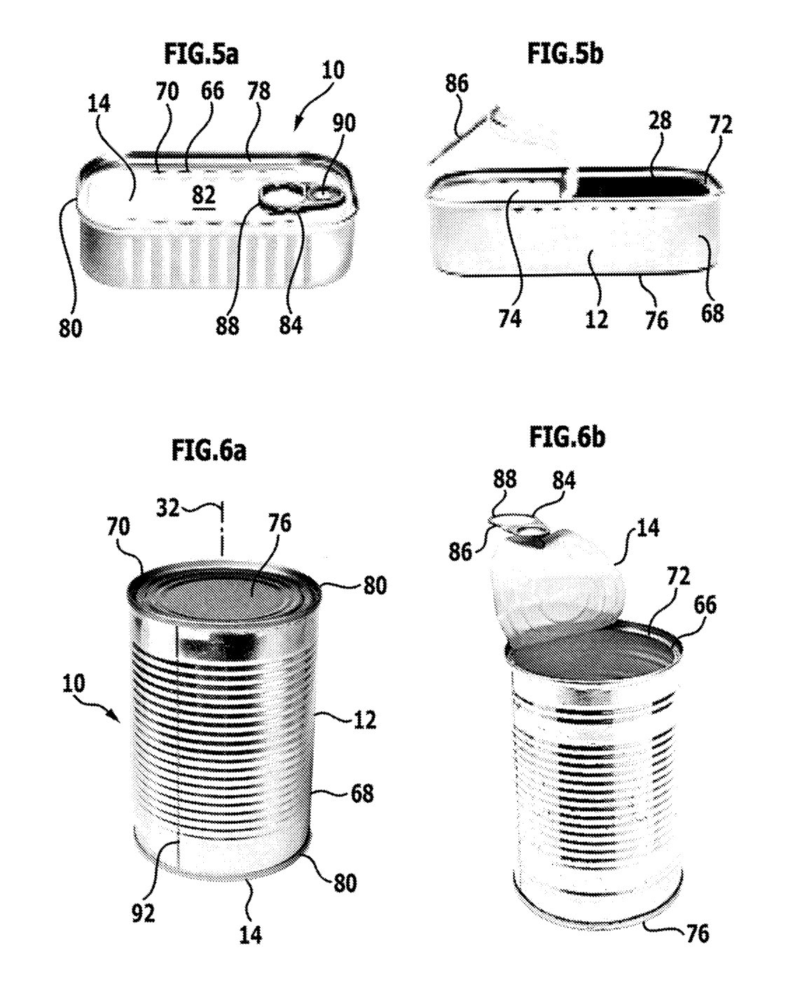

A fifth embodiment of a sterile packaging 10 is schematically shown in FIGS. 5a and 5b. It comprises a trough-like container 12, which has an open upper side 74, which is closed by a substantially plate-shaped closure element 14. A peripheral wall 68 projecting from a base of the container 12 in the direction of the closure element 14 is folded over in the direction of the receiving space 28 and engages over a flange-like peripheral edge 78, which is directed away from the base 76, of the closure element 14. By means of this folding over or beading, the closure element 14 is connected to the container 12 in a permanent and gas-tight manner. The beading 80 can additionally be secured by welding or gluing.

A groove 70 facing away from an outside 82 of the closure element 14 and running parallel to the edge 78 is furthermore provided on the closure element 14 to form a predetermined breaking point 66. A tool element 84 is connected to the closure element 14, specifically in the form of a pull member 86, which is configured as a pull tab 88. It is connected by a rivet 90 to the closure element 14 and/or optionally welded or glued.

To open the sterile packaging 10, the pull tab 88 abutting on the closure element 14 in the storage disposition is lifted from the outside 82 and a tensile force is then exerted thereon. The closure element 14 then tears along the groove 70, so the closure element 14 can be pulled off by means of the pull member 86, so a removal opening 72 is formed in order to remove the implant 26 contained in the sterile packaging 10.

A sixth embodiment of a sterile packaging 10 is shown schematically in FIGS. 6a and 6b, specifically in the storage disposition in FIG. 6a. The structure of the sterile packaging 10, as shown by way of example in FIGS. 6a and 6b, structurally corresponds to the structure of the sterile packaging 10 shown schematically in FIGS. 5a and 5b. However, the difference is substantially in the shape of the sterile packaging 10. Thus, the container 12 comprises a cylindrical wall 68, which is formed from a cylindrically bent sheet metal part, which has two edges connected by a weld seam 92 running lengthways parallel to the longitudinal axis 32. The base 76, like the closure element 14, is connected to the wall 68 by forming a beading 80.

Formed on the closure element 14 is a predetermined breaking point 66 in the form of an annularly closed groove 70, along which the closure element 14 can be torn open by means of the tool element 84, which is formed as a pull member 86.

The sterile packagings 10 according to the fifth and sixth embodiments are preferably formed from a metal, specifically, for example, from a non-rusting metal sheet or high-grade steel.

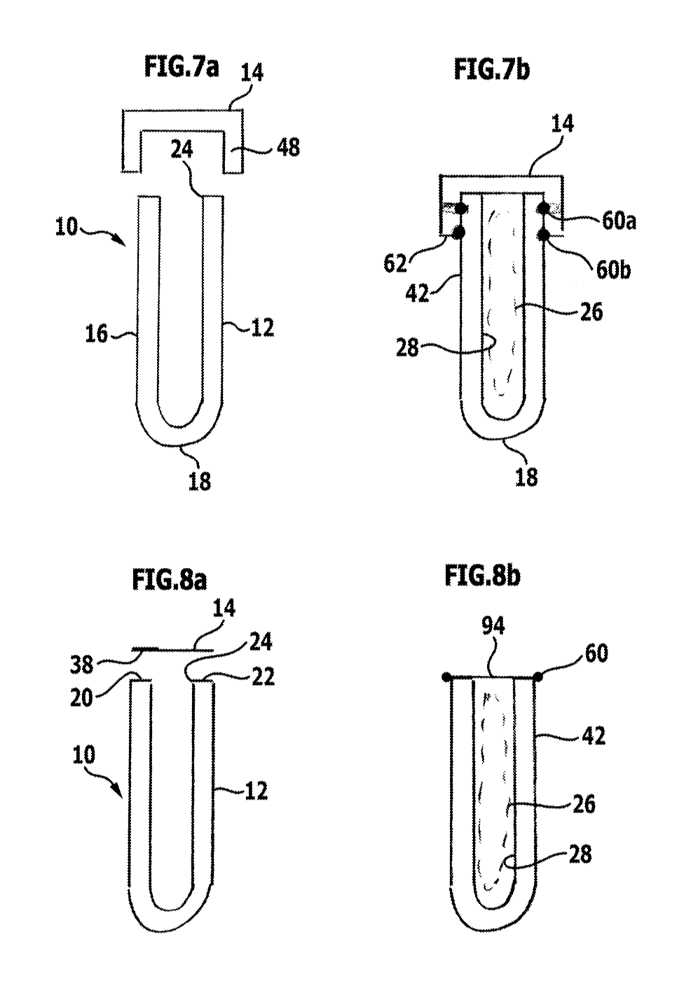

FIGS. 7a and 7b schematically show a seventh embodiment of a sterile packaging 10. The container 12 and the closure element 14 coincide with respect to structure substantially with the second embodiment of the sterile packaging 10, which is shown in FIGS. 2a and 2b and differ therefrom only in that no threaded portions are provided on the container 12 and on the closure element 14. The fastening of the closure element 14 on the container 12 takes place by means of welding, specifically by forming a first weld seam 66a between the portion 48 and the outside 42 of the container 12, by means of which the latter is pushed into the storage disposition shown in FIG. 7b, and a second weld seam 66b in the transition region between the annular face 62 of the portion 48, which is oriented in the direction of the end 18 and the outside 42. A redundant, namely double, seal of the receiving space 28 can thus be formed.

An eighth embodiment of a sterile packaging 10 is shown schematically in FIGS. 8a and 8b. The container 12 of this embodiment substantially corresponds to the container 12 of the first embodiment of the sterile packaging 10 shown in FIGS. 1a and 1b. The closure element 14 is, however, formed by a thin, circular disc-shaped metal sheet 94, the lower side of which defines the closure element sealing face 38, which, in the storage disposition shown in FIG. 8b, abuts on the edge face 22. Instead of the metal sheet 94, an adequately thick, durable foil/film can be used, which is optionally formed from a plurality of layers or plies. The layers may be produced from a metal or a plastics material, any combination of different materials being possible.

Once the implant 26 has been introduced into the receiving space 28, the closure element 14 is placed on the end 20 and welded to the container 12, so a peripheral weld seam 60 connecting the outside 42 and the metal sheet 94 is formed.

This sterile packaging 10 can, for example, be opened by means of a conventional tin opener by cutting open or severing the metal sheet 94.

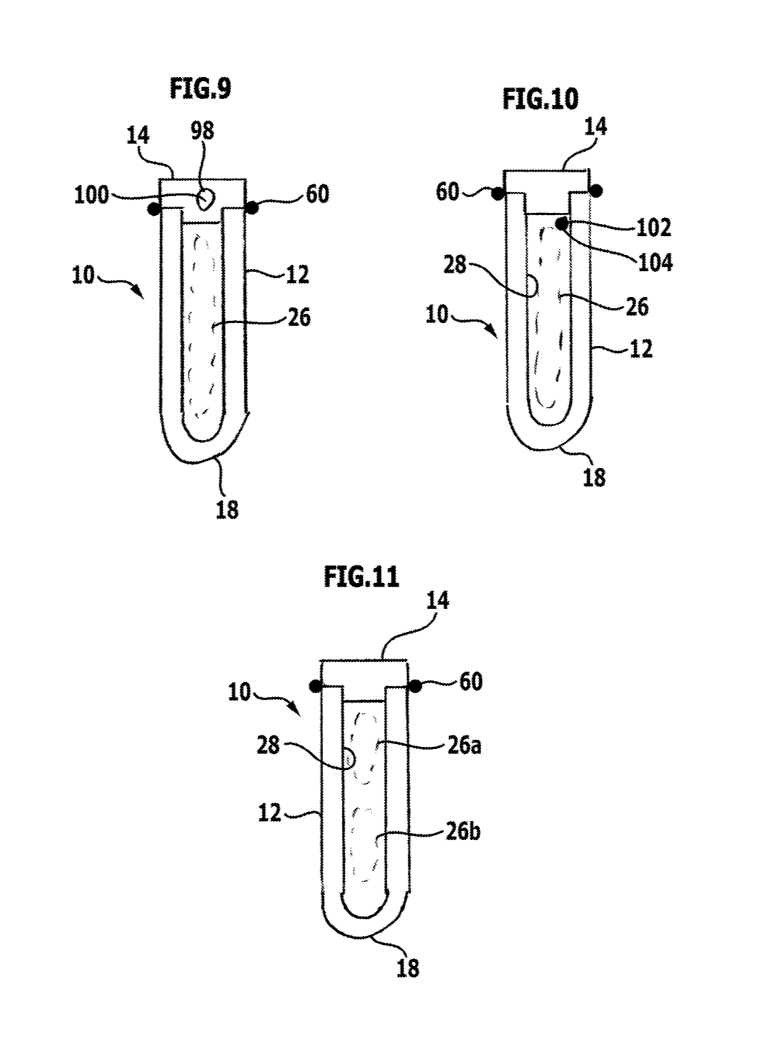

FIG. 9 schematically shows a ninth embodiment of a sterile packaging 10 by way of example. It substantially corresponds with respect to its structure to the first embodiment of the sterile packaging 10 shown schematically in FIGS. 1a and 1b. In addition, a memory element 98 is, however, also arranged on the sterile packaging 10, specifically, for example, on or in the closure element 14. The memory element 98 is preferably an RFID chip 100, which can be moulded into the closure element 14 formed from a plastics material. Information to characterise the implant 26, for example the type of implant 26, information about its size and production date, batch designation and/or individual production or series number, can be stored in the memory element 98.

The memory element 98 can selectively also be arranged on the container 12. Optionally, instead of an RFID chip 100, a barcode, which is not shown in the Figures, can also be used, which also allows contactless reading of the stored information. The barcode can be permanently applied to the sterile packaging by means of laser inscription.

Obviously, all the embodiments of the sterile packaging 10 described above and also below can be equipped with a memory element 98.

A tenth embodiment of a sterile packaging 10 is shown schematically in FIG. 10. With respect to its structure, it also substantially corresponds to the first embodiment of the sterile packaging 10 shown schematically in FIGS. 1a and 1b. However, it additionally comprises an indicator device 102 to indicate whether the sterile packaging 10 has been opened or damaged. The indicator device 102 preferably comprises an oxygen indicator 104, which is arranged in the receiving space 28. This may, for example, be configured in such a way that when it comes into contact with oxygen, it changes its colour, so that, for example, when the container and/or the closure element 14 are formed from a translucent or transparent material, it can immediately be recognised by a user whether oxygen has undesirably reached the receiving space 28. If contact with oxygen is indicated by the display device 102, it is to be assumed with a high degree of probability that the implant 26 packaged in the receiving space 28 no longer has the required sterility for a surgical intervention.

Obviously, all the embodiments described above and below of the sterile packaging 10 can also optionally be equipped with an indicator device 102.

FIG. 11 schematically shows an eleventh embodiment of a sterile packaging 10. With respect to its structure, this corresponds to the first embodiment of the sterile packaging 10 shown in FIGS. 1a and 1b.

It is obviously possible to introduce two or more implants 26a and 26b into the receiving space 28. This is not only possible in the eleventh embodiment shown in FIG. 11, but basically in all the above-described embodiments. In order to avoid confusion, identical implants 26a and 26b are preferably introduced into the receiving space 28 of the sterile packaging 10.

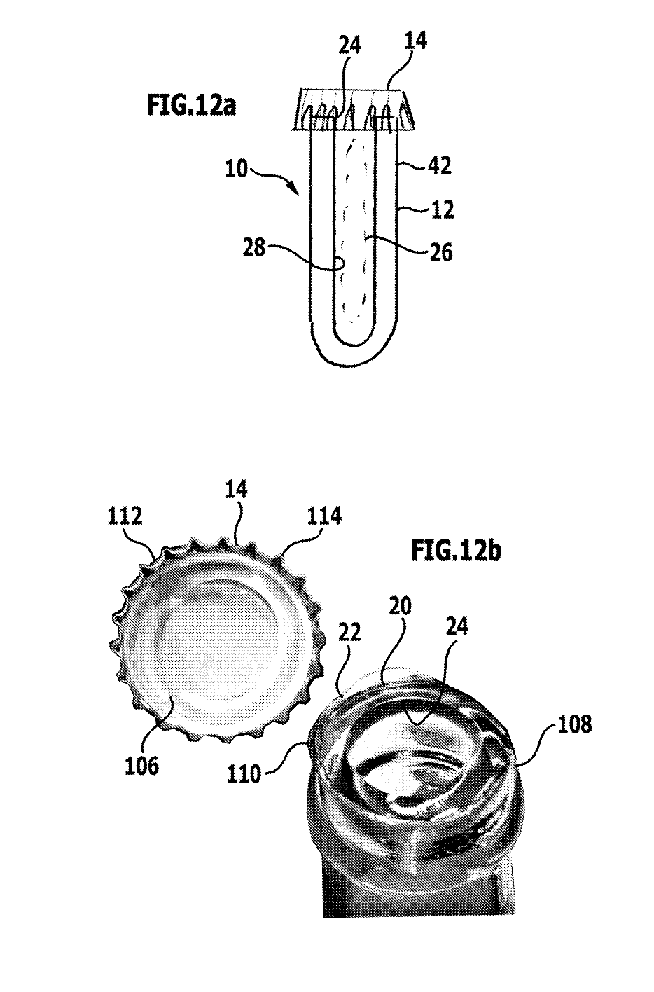

A twelfth embodiment of a sterile packaging 10 is shown schematically in FIGS. 12a and 12b. With respect to its structure, the container 12 substantially corresponds to the container 12 of the first embodiment of the sterile packaging 10 shown in FIGS. 1a and 1b. An annular groove 108 facing away from the exterior 42 is preferably formed in the region of the end 20, so a bead-like thickening 110 is formed at the end 20. The closure element 14 in the form of a crown cap 112 is pushed thereon and crimped by the formation of a plurality of points 114 on the thickening 110. A sealing element 106 is arranged on an inside of the crown cap 112 in order to seal the closure element 14 relative to the container 12. The sealing element 106, in the storage disposition shown schematically in FIG. 12a, abuts on the edge face 22 of the container 12.

The container 12, in this embodiment, can selectively be formed from a metal, a plastics material or also of glass. The closure element 14 is preferably formed from a metal sheet and the sealing element is formed from a plastics material, preferably a resilient plastics material or at least partially resilient plastics material. Sterilisable plastics materials such as polyethylene, polyvinyl chloride or polyetheretherketone are possible, for example.

In conclusion, it should be pointed out that the features of the described embodiments of the sterile packaging 10 described above and shown schematically in the Figures can basically be combined with one another as desired, in other words both the shaping of the container 12 and of the closure element 14 and also the manner in which they are connected to one another. Force-locking or substance-to-substance bonds of the container 12 with the closure element 14 are, in particular, produced by welding or, depending on the materials used, with adhesives 52 suitable for this.

1. Medical sterile packaging, which defines a receiving space for at least one implant, which is formed for temporary or permanent insertion in a human or animal body, which receiving space is closed in a sterile and germ-proof manner in a storage disposition of the sterile packaging for the sterile packaging of the at least one implant, wherein the sterile packaging is produced from one or more cleanable and sterilisable materials.

2. Medical sterile packaging according to claim 1, wherein the one or more cleanable and sterilisable materials are solvent-resistant to cleaning agents and solvents with a pH in a range from about 2 to about 12, in particular in a range from about 3 to about 11.

3. Medical sterile packaging according to claim 1, wherein the one or more cleanable and sterilisable materials are heat-resistant up to a temperature of about 150° C., in particular up to a temperature of about 130° C.

4. Medical sterile packaging according to claim 1, wherein the one or more cleanable and sterilisable materials are pressure resistant at pressures up to at least about 5 bar, in particular at pressures up to at least about 3 bar.

5. Medical sterile packaging according to claim 1, wherein the sterile packaging is dimensionally stable, in particular at temperatures up to a at least 130° C. and at pressures up to at least about 3 bar.

6. Medical sterile packaging according to claim 1, wherein the one or more cleanable and sterilisable materials are transparent or translucent.

7. Medical sterile packaging according to claim 1, wherein the one or more cleanable and sterilisable materials are glass, metal, plastics material or ceramics.

8. Medical sterile packaging according to claim 1, wherein the sterile packaging comprises a container to receive at least one implant with an introduction opening and a closure element to close the introduction opening.

9. Medical sterile packaging according to claim 8, wherein, in the storage disposition, the container and the closure element are connected to one another in at least one of force-locking and shape-locking manner, in particular at least one of glued and welded, furthermore in particular welded by a laser.

10. Medical sterile packaging according to claim 8, wherein at least one weld seam is provided to connect the container and the closure element in the storage disposition, in particular at least one weld seam in the form of a closed ring.

11. Medical sterile packaging according to claim 1, wherein the sterile packaging has at least one predetermined breaking point for opening.

12. Medical sterile packaging according to claim 11, wherein the predetermined breaking point is formed at least one of on the container and on the closure element.

13. Medical sterile packaging according to claim 11, wherein the predetermined breaking point is formed by a weakening of the material forming at least one of the container and the closure element, or comprises a groove, in particular a groove open in a direction facing away from the sterile packaging.

14. Medical sterile packaging according to claim 8, wherein the container and the closure element are configured to be screwed to one another.

15. Medical sterile packaging according to claim 8, wherein the closure element has a wall portion annularly surrounding the container in the region of the introduction opening.

16. Medical sterile packaging according to claim 8, wherein the closure element is in the form of a crown cap.

17. Medical sterile packaging according to claim 8, further comprising a sealing element to seal the container and the closure element relative to one another.

18. Medical sterile packaging according to claim 8, wherein the closure element is produced from at least one of a foil and film, in particular at least one of a metal and plastics material foil and a metal and plastics material film.

19. Medical sterile packaging according to claim 8, further comprising at least one tool element for at least partially removing the closure element to open the sterile packaging.

20. Medical sterile packaging according to claim 1, further comprising an indicator device to indicate whether the sterile packaging has been opened or damaged.

21. Medical sterile packaging according to claim 20, wherein the indicator device comprises an oxygen indicator.

22. Medical sterile packaging according to claim 1, further comprising at least one memory element for storing information to characterise at least one implant packaged in the sterile packaging.

23. Medical sterile packaging according to claim 22, wherein the memory element can be read contactlessly and, in particular, is in the form of at least one of a bar code and a colour coding and part of an RFID chip.

24. Medical sterile packaging according to claim 1, further comprising at least one implant packaged in the receiving space in the storage disposition.

25. Packaging method for the sterile packaging of at least one implant, which is formed for temporary or permanent insertion in a human or animal body, said method comprising:
Packaging the at least one implant in a medical sterile packaging, which defines a receiving space for at least one implant, which is formed for temporary or permanent insertion in a human or animal body, which receiving space is closed in a sterile and germ-proof manner in a storage disposition of the sterile packaging for the sterile packaging of the at least one implant, wherein the sterile packaging is produced from one or more cleanable and sterilisable materials.
